(19) United States
(12) Patent Application Publication
(10) Pub. No.: US 2009/0076828 A1
(43) Pub. Date: Mar. 19, 2009

(54) SYSTEM AND METHOD OF DATA ENCODING

(75) Inventor: Dunling Li, Rockville, MD (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/198,586

(22) Filed: Aug. 26, 2008

Related U.S. Application Data
(60) Provisional application No. 60/968,094, filed on Aug. 27, 2007.
(60) Provisional application No. 60/982,925, filed on Oct. 26, 2007.

(51) Int. Cl. G10L 19/00

(52) U.S. Cl. 704/500; 704/E19.001

(57) ABSTRACT

A data encoding device is provided, comprising: a data frame encoder configured to receive an incoming frame of data and to generate an encoded frame of data using a frame encoding scheme; a data frame decoder configured to receive the encoded frame of data and to generate a decoded frame of data using the frame encoding scheme, and frame decoding parameters; a subtractor configured to subtract the decoded frame of data from the incoming frame of data to generate base quantization noise information; a quantization noise encoder configured to receive the base quantization noise information and the frame decoding parameters, and to generate encoded quantization noise information using a noise encoding scheme; and a transmitting circuit configured to transmit the encoded frame of data and the encoded quantization noise information.

### CROSS REFERENCE TO RELATED APPLICATIONS

The present invention claims priority to Untied States provisional application 60/968,094, filed on 27 Aug. 2007, and Untied States provisional application 60/982,925, filed on 26 Oct. 2007, both of which are incorporated by reference in their entirety.

### TECHNICAL FIELD

The present invention relates in general to signal processing. More specifically it relates to a system and method for encoding and decoding uncorrelated quantization noise in a signal to be transmitted.

### BACKGROUND

Data representing voice, video, or audio may be generated at a variety of signal qualities, depending upon how much data is provided to represent the signal, with greater amounts of data allowing for richer sound or more detailed video. However because of limited available bandwidth in most data transmission or encoding schemes, the amount data that may be used to represent voice, video, or audio will generally be limited (i.e., only a certain amount of bandwidth will be allowed to represent the voice, video, or audio).

For example, a variety of standards, such as G.729, MPEG 4, G.711, all limit the allowable bandwidth for the data they process. Each of these standards uses a corresponding coder-decoders (codecs) to limit the transmitted data.

In each of these codecs, a signal to be transmitted can be reduced to a maximum allowed data rate by sampling the signal using parameters defined in the codec. The data can then be transmitted (over a transmission medium, such as a wire or the air; to a storage medium, such as a disk drive or a compact disk; etc.) at the maximum allowed data rate. Then, when it must be displayed, played, or otherwise used, the process can be reversed to generate the voice, video, or audio data again.

In some cases, the codec can sample the data uniformly. But in others, the sampling will not be uniform. The codec may determine where it believes that more granularity is required for quantization and where less granularity is required. In this case, more data will be allowed for some portions of the signal than others.

For example, a G.711 codec, sometimes called pulse code modulation (PCM), uses a non-uniform quantization operation. The G.711 has a sampling rate of 8000 samples per second, and uses 8 bits to represent a given sample, providing for a 64 kilobit per second (kbps) bit stream. However, the G.711 codec uses a logarithmic encoding scheme such that greater resolution is provided for portions of the signal with lower signal level. One implementation of the G.711 codec is μlaw, which is used in North America, and which gives more resolution to higher range signals. Another implementation is alaw, which is used outside of North America, and which provides more quantization levels at lower signal levels

Regardless of how the various codecs are implemented, however, all of them necessarily reduce the quality for any signals received at a significantly high data rates because the codec performs sampling to limit the bandwidth of the encoded signal. In cases where the codec's sampling rate is not sufficient to guarantee full quality of the received signal, there will necessarily be some loss of signal quality caused by the quantization.

However, the quantization noise can be measured at a transmitter. And if a value for the quantization noise were known when an encoded signal was being decoded, the quality of the decoded signal could be improved. It would therefore be desirable to provide a system and method that allows data representative of quantization noise to be sent along with encoded data for transmission to allow for a clearer decoding of the data at a receiver.

### SUMMARY

Accordingly, a data encoding device is provided, comprising: a data frame encoder configured to receive an incoming frame of data and to generate an encoded frame of data using a frame encoding scheme; a data frame decoder configured to receive the encoded frame of data and to generate a decoded frame of data using the frame encoding scheme, and frame decoding parameters; a subtractor configured to subtract the decoded frame of data from the incoming frame of data to generate base quantization noise information; a quantization noise encoder configured to receive the base quantization noise information and the frame decoding parameters, and to generate encoded quantization noise information using a noise encoding scheme; and a transmitting circuit configured to transmit the encoded frame of data and the encoded quantization noise information.

The frame encoding scheme may be determined based on a G.711 wideband enhancement codec, the encoded data frame may be formed in a layer one bit stream, the encoded quantization noise information may be formed in a layer two bit stream, and the transmitting circuit may be configured to transmit the layer one and layer two bit streams.

The device may further comprise a first packing circuit configured to pack the encoded frame of data into a first bit stream; and a second packing circuit configured to pack the encoded quantization noise information into a second bit stream, wherein the transmitting circuit is configured to merge the first and second bit streams into a third bit stream, and to transmit the third bit stream over a transmission medium.

The frame decoding parameters may include quantization index values for the data frame decoder and quantization step size values for the data frame decoder. The encoding of the base quantization noise information may comprise calculating a probability density function of the base quantization noise information. The frame encoding scheme may be determined based on a G.711 codec.

The coding scheme coder may be configured to quantize the incoming frame of data for a bit rate of 64 kilobits per second, and the quantization noise encoder may be configured to quantize the base quantization noise information for a bit rate of 16 kilobits per second.

A method of encoding an incoming frame of data is also provided, comprising: receiving the incoming frame of data; encoding the incoming frame of data using a frame encoding scheme to generate an encoded frame of data; decoding the encoded frame of data using a frame decoding scheme to generate a decoded frame of data and decoding data; subtracting the decoded frame of data from the incoming frame of data to generate base quantization noise information; encoding the base quantization noise information using a quantization noise encoding scheme and the decoding parameters to generate encoded quantization noise information; and transmitting the encoded frame of data and the encoded quantization noise information over a transmission medium, wherein the encoding of the base quantization noise information is performed using parameters based on the decoding of the encoded frame of data.

The method may further comprise packing the encoded frame of data into a first bit stream; packing the encoded quantization noise information into a second bit stream; and merging the first and second bit streams into a third bit stream, wherein the transmitting of the encoded frame of data and of the encoded quantization noise information includes transmitting the third bit stream.

The frame decoding parameters may include frame quantization index values for the decoding of the encoded frame of data and quantization segment step size values for the decoding of the encoded frame of data.

The encoding of the base quantization noise information may further comprise: determining a plurality of bit sizes for encoding a plurality of segments of the base quantization noise information; and determining a plurality of noise quantization step size values for a plurality of segments of the base quantization noise information based on the plurality of frame quantization step size values and the plurality of bit sizes.

In this method, the frame of data may be divided up into M segments, the frame of data may be represented by B bits of data, the number of bits bᵢ for an i^{th} quantization segment of the quantization noise is equal to

$${b}_{i} = ⌊ {log}_{2} ( {t}_{i} ) - {\sum }_{j = 1}^{M} {P}_{i} {log}_{2} ( {t}_{j} ) + B ⌋ ,$$

the noise quantization step size value for the i^{th} quantization segment of the quantization noise may be equal to

$${s}_{i} = \frac{{t}_{i}}{{2}^{{b}_{i}}} , {t}_{i}$$

may be a quantization segment step size value for the i^{th} quantization segment of the quantization noise, and Pᵢ may be a probability density function for the i^{th} quantization segment of the quantization noise, wherein M, B, bᵢ, are all integers.

The encoding of the base quantization noise information may comprise calculating a probability density function of the quantization noise information. The encoding of the incoming frame of data and the decoding of the encoded frame of data may both be performed using a G.711 codec.

A data decoding device is also provided, comprising: a receiving circuit configured to receive an encoded frame of data and encoded quantization noise information; a data frame decoder configured to receive the encoded frame of data and to generate a decoded frame of data using a frame encoding scheme, and frame decoding parameters; a quantization noise decoder configured to receive the encoded quantization noise information and the frame decoding parameters, and to generate a decoded quantization noise information using a noise decoding scheme; and an adder configured to add the decoded frame of data and the quantization noise information to generate a reconstructed data frame.

The frame decoding scheme may be determined based on a G.711 wideband enhancement codec, the encoded frame of data may be formed in a layer one bit stream, the encoded quantization noise information may be formed in a layer two bit stream, and the receiving circuit may be configured to receive the layer one and layer two bit streams and to extract the encoded frame of data and the encoded quantization noise value.

The device may further comprise: a first unpacking circuit configured to unpack the first bit stream to retrieve the encoded frame of data; and a second unpacking circuit configured to unpack the second bit stream to retrieve the encoded quantization noise information, wherein the receiving circuit is configured to receive a third bit stream containing the first and second bit streams, and to extract the first and second bit streams from the third bit stream.

The frame decoding parameters may include quantization index values for the data frame decoder and quantization step size values for the data frame decoder. The decoding of the base quantization noise information may comprise calculating a probability density function of the quantization noise information. The frame encoding scheme may be determined based on a G.711 codec.

A method is also provided of generating a reconstructed frame of data, comprising: receiving an encoded frame of data and an encoded quantization noise information; decoding the encoded frame of data using a frame decoding scheme to generate a decoded frame of data and decoding data; decoding the encoded quantization noise information using a quantization noise decoding scheme and the decoding parameters to generate a decoded quantization noise information; and adding the decoded frame of data and the decoded quantization noise information to generate the reconstructed frame of data.

The method may further comprise: splitting a third bit stream into a first bit stream containing the encoded frame of data and a second bit stream containing the encoded quantization noise information; unpacking the first bit stream to retrieve the encoded frame of data; and packing the second bit stream to retrieve the encoded quantization noise information, wherein the receiving of the encoded frame of data and the encoded quantization noise value includes receiving the third bit stream.

The frame decoding parameters may include frame quantization index values for the decoding of the encoded frame of data and quantization segment step size values for the decoding of the encoded frame of data.

The decoding of the base quantization noise information may further comprise: determining a plurality of bit sizes for decoding a plurality of segments of the encoded quantization noise information; and determining a plurality of noise quantization step size values for a plurality of segments of the encoded quantization noise information on the plurality of quantization segment step size values and the plurality of bit sizes.

The decoding of the encoded quantization noise information may comprise calculating a probability density function of the quantization noise information.

The dynamic range of data may be divided up into M stages, the encoded frame of data may be represented by B bits of data, the number of bits bᵢ for an i^{th} stage of the encoded frame of data may be equal to

$${b}_{i} = ⌊ {log}_{2} ( {t}_{i} ) - {\sum }_{j = 1}^{M} {P}_{i} {log}_{2} ( {t}_{j} ) + B ⌋ ,$$

the noise quantization step size value for the i^{th} stage of the encoded frame of data may be equal to

$${s}_{i} = \frac{{t}_{i}}{{2}^{{b}_{i}}} , {t}_{i}$$

where tᵢ is a quantization segment step size value for the i^{th} stage of the encoded frame of data, Pᵢ is a probability density function for the i^{th} stage of the encoded frame of data, and M, B, bᵢ, are all integers.

The decoding of the encoded frame of data may be performed using a G.711 codec.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the embodiments.

FIG. 1 is a block diagram of a transmitter device according to disclosed embodiments;

FIG. 2 is a block diagram of a receiver device according to disclosed embodiments;

FIG. 3 is a flow chart of a data quantization encoding operation according to disclosed embodiments;

FIG. 4 is a flow chart of a quantization noise encoding operation in the data quantization encoding operation of FIG. 3 according to disclosed embodiments;

FIG. 5 is a flow chart of a data quantization decoding operation according to disclosed embodiments; and

FIG. 6 is a flow chart of a quantization noise decoding operation in the data quantization decoding operation of FIG. 5 according to disclosed embodiments.

### DETAILED DESCRIPTION

In overview, the present disclosure concerns the improving the quality of a quantized signal.

This objective of improving the quality of a quantized signal is accomplished by sending information related to the quantization noise of a data quantization process along with the quantized data. In particular, this is achieved by calculating the quantization noise at a transmitter, encoding the quantization noise at the transmitter, and sending the encoded quantization noise along with the quantized data to a receiver.

The instant disclosure is provided to further explain in an enabling fashion the best modes of performing one or more embodiments. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore, and/or application specific ICs, along with a variety of memory types. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation, and would be aware of the many types of available computer memory. Therefore, in the interest of brevity and minimization of any risk of obscuring principles and concepts, further discussion of such software, ICs, and memory elements, if any, will be limited to the essentials with respect to the principles and concepts used by the exemplary embodiments.

In addition, although the discussion of the embodiments below focuses on the G.711 codec, this is by way of example only. The claimed invention should not be limited to the G.711 codec, but can apply to any codec that quantizes data prior to transmitting the data. For example, it could apply to a G.729 codec, an MPEG 4 codec, or any suitable voice, audio or video codec.

Quantization Encoding and Decoding

As noted above, to limit the bandwidth used to send or store data, the data can be quantized into a smaller set of data for storage or transmission. Quantization is the process of approximating a continuous range of values or a very large set of possible discrete values by a relatively small set of discrete symbols or integer values. Quantization noise is then generated due to the information loss from many-to-one mapping. The simplest and best-known form of quantization is referred to as scalar quantization. The scalar quantizer is defined by its quantization step size t. If x is a quantizer input, then its output y can be expressed as

y= [symbol] x/t [symbol] t=nt, (1)

where n= [symbol] x/t [symbol] and [symbol] x [symbol] is the integer whose value is the closest to x. Obviously, the quantization output is the de-quantizer output, i.e., the quantized x. If x ε[Xₘᵢₙ, Xₘₐₓ], then n ε[Nₘᵢₙ, Nₘₐₓ], Nₘᵢₙ= [symbol] Xₘᵢₙ/t [symbol] , Nₘₐₓ= [symbol] Xₘₐₓ/t [symbol] . The quantization noise q can be defined as the difference between the quantizer input and its output:

q=x−y=x−nt, (2)

where q ε[−t/2, t/2].

q=x−nt, (3)

where n= [symbol] x/t [symbol] .

If pₓ(x) is the probability density function (PDF) of the quantization input, then the PDF of its quantization noise is:

$$\begin{matrix}{p}_{q} ( q ) = {\sum }_{n = {N}_{min}}^{{N}_{max}} {p}_{x} ( x - nt ) = {\sum }_{n = {N}_{min}}^{{N}_{max}} {p}_{n} ( q ) , \\ where , & ( 4 ) \\ {p}_{n} ( q ) = \{ \begin{matrix}{p}_{x} ( q + nt ) & q ∈ [ - t / 2 , t / 2 ) \\ 0 & otherwise\end{matrix} . & ( 5 )\end{matrix}$$

The mean and variance of quantization noise are therefore:

$$η = {\sum }_{n = {N}_{min}}^{{N}_{max}} {\int }_{- \frac{t}{2} + nt}^{\frac{t}{2} + nt} ( x - nt ) {p}_{x} ( x ) d x , \qquad ( 6 )$$

and:

$${σ}^{2} = {\sum }_{n = {N}_{min}}^{{N}_{max}} {\int }_{( n - 1 / 2 ) t}^{( n + 1 / 2 ) t} {( x - nt - η )}^{2} {p}_{x} ( x ) d x . \qquad ( 7 )$$

The quantization noise distribution varies with quantization step sizes and its input. However, for a high resolution quantizer and smooth density of quantization input, the quantization noise has low correlation with input samples and has a flat spectrum. The quantization noise is uniformly distributed between −t/2 and t/2 when the input of the quantizer satisfies Bennett's high-resolution condition. The variance of uniform quantizer with quantization step size t is

σ²=t²/12. (8)

One exemplary method of performing data quantization is the G.711 codec, which is described below. The G.711 codec takes a high-speed input (e.g., 128 kbps) and reduces it to a lower-speed signal (e.g., 64 kbps) by quantizing the input signal using a logarithmic encoding scheme.

Furthermore, in some cases, additional bandwidth may be provided within a given codec above what is allocated for data. For example, some enhancements of the G.711 codec allows for two possible bandwidth increases: a narrowband (or low band) enhancement (allowing an additional 16 kbps of data) and a wideband enhancement (also allowing an additional 16 kbps of data). According to the embodiments disclosed below, this additional bandwidth can be used to transmit information regarding the quantization noise caused by the quantization of the data. Under such a system, it is then possible to not only send the quantized data signal, but also an additional signal representative of the quantization noise as well. In some cases, when the quantization noise is itself larger than the additional bandwidth, it too can be encoded to allow it to pass through the allowable bandwidth.

For example, in a narrow band enhancement (NBE) of the G.711 standard, the core layer (R1) is the G.711 μlaw/alaw, having a bit rate of 64 kbps. An NBE layer, having a bit rate of 16 kbps, may then be added on top of the core layer. This NBE layer can be used to reduce the quantization distortion from G.711 and to enhance G.711 speech quality. An exemplary way that this can be accomplished is to reduce quantization noise in terms of its minimum mean square error (i.e., the measure of the distortion of a data quantization process) for a given bandwidth. And one way to achieve this reduction is to measure quantization noise at the transmitter, and pass this information (in some form) to the receiver.

As noted above, the G.711 codec defines a logarithmic quantizer that is implemented as a multi-segment uniform scalar quantizer whose quantization step size t is function of quantization input x, i.e.

t=f(x)=tᵢ if X εDᵢ, (9)

where Dᵢ=[Xᵢ, Xᵢ₋₁]; i=1, 2, . . . , M; M is the number of segments used in the quantization (e.g., M=7 for alaw and M=8 for μlaw); and X₁ and X_{M+1} are the minimum and maximum values of the quantization input x.

Given this, the probability density function (PDF) of quantization noise for an M-segment scalar quantizer (M-SSQ) will be:

$${p}_{q} ( q ) = {\sum }_{i = 1}^{M} {\sum }_{n = 0}^{{N}_{i}} {p}_{x} ( x - {nt}_{i} - {X}_{i} ) = {\sum }_{i = 1}^{M} {\sum }_{n = {N}_{i , min}}^{{N}_{i , max}} {p}_{i , n} ( q ) \qquad ( 10 )$$

where N_{i,min} and N_{i,max} are the minimum and maximum quantization indexes for an i-segment uniform scalar quantizer, and

$${p}_{i , n} ( q ) = \{ \begin{matrix}{p}_{x} ( q + {nt}_{i} - {X}_{i} ) & q ∈ [ - {t}_{i} / 2 , {t}_{i} / 2 ) \\ 0 & otherwise\end{matrix} . \qquad ( 11 )$$

The mean of the M-SSQ can be shown to be:

$$η = {\sum }_{i = 1}^{M} {\sum }_{n = 0}^{{N}_{i}} {\int }_{( n - 1 / 2 ) {t}_{i}}^{( 1 + 1 / 2 ) {t}_{i}} ( x - {nt}_{i} - {X}_{i} ) {p}_{x} ( x ) d x , \qquad ( 12 )$$

and the variance of the M-SSQ can be shown to be:

$${σ}^{2} = {\sum }_{i = 1}^{M} {\sum }_{n = 0}^{{N}_{i}} {\int }_{( n - 1 / 2 ) {t}_{i}}^{( 1 + 1 / 2 ) {t}_{i}} {( x - {nt}_{i} - {X}_{i} - η )}^{2} {p}_{x} ( x ) d x . \qquad ( 13 )$$

Furthermore, since in the G.711 codec, the quantization step sizes are relatively small compared with corresponding quantization inputs, the quantization noise of each segment approaches a uniform distribution. Therefore, the variance of quantization noise can be simplified as:

$${σ}^{2} = {\sum }_{i = 1}^{M} {P}_{i} {t}_{i}^{2} / 12 , \qquad ( 14 )$$

where Pᵢ is the probability that the quantization input is from i^{th} quantization segment, i.e.,

$${P}_{i} = {\int }_{{X}_{i}}^{{X}_{i + 1}} {p}_{x} ( x ) d x . \qquad ( 15 )$$

To reduce G.711 quantization distortion in the enhancement layer, the quantization noise can be further quantized for a given bit rate 16 kbps, i.e. 2 bits/sample. And since quantization noise tends to be independent for different quantization step sizes, the correlation of quantization noise among neighbors is not high. Therefore, a uniform scalar quantizer can be used for G.711 quantization noise in each segment. As a result, if bᵢ is the number of bits for quantization noise at i^{th} quantization segment, then the new quantization step size sᵢ will be:

Sᵢ=tᵢ/2^{b}^{ᵢ}, (16)

where tᵢ is the quantization step size of the i^{th} quantization segment in G.711. As a result, the overall quantization distortion, i.e. the variance of new quantization noise, will be:

$${σ}_{new}^{2} = {\sum }_{i = 1}^{M} {P}_{i} {s}_{i}^{2} / 12 = {\sum }_{i = 1}^{M} {P}_{i} {t}_{i}^{2} {2}^{- 2 {b}_{i}} / 12. \qquad ( 17 )$$

Furthermore, if B is the average number of bits/sample for the M-SSQ quantization noise encoding, then:

$${\sum }_{i = 1}^{M} {b}_{i} {P}_{i} = B . \qquad ( 18 )$$

As a result, the optimum quantizer of M-SSQ quantization noise can be designed by using the following cost function:

$$Δ = {\sum }_{i = 1}^{M} {P}_{i} {t}_{i}^{2} {2}^{- 2 {b}_{i}} / 12 + λ {\sum }_{i = 1}^{M} ( {b}_{i} {P}_{i} - B ) . \qquad ( 19 )$$

And so, to calculate optimum bit allocation bᵢ, it is possible to set:

$$\frac{\partial Δ}{\partial {b}_{i}} = - {P}_{i} ln ( 4 ) {t}_{i}^{2} {4}^{- {b}_{i}} / 12 + {λP}_{i} = 0 , \qquad ( 20 )$$

for i=1, 2, . . . , M.

And based on this:

$${b}_{i} = {log}_{2} ( {t}_{i} ) - {\sum }_{j = 1}^{M} {P}_{j} {log}_{2} ( {t}_{j} ) + B . \qquad ( 21 )$$

In this equation bᵢ must be a positive number (i.e., bᵢ≧0). And the probability Pⱼ can be calculated by:

Pⱼ=Nⱼ/N, (22)

where Nⱼ is the number of samples in the j^{th} quantization segment, and N is the number of samples per frame,

$$N = {\sum }_{i = 1}^{M} {N}_{i} . \qquad ( 23 )$$

Since the number of bits, bᵢ, must be an integer, bᵢ can be chosen to be the floor value for equation (13). Therefore, the number of remaining bits per frame can be determined to be:

$${B}_{left} = NB - N {\sum }_{i = 1}^{M} {P}_{i} ⌊ {log}_{2} ( {t}_{i} ) - {\sum }_{j = 1}^{M} {P}_{j} {log}_{2} ( {t}_{j} ) + B ⌋ . \qquad ( 24 )$$

The remaining bits can then be assigned to the segments in which the number of samples is less than B_{left} based on the noise reduction amount:

3/4·(sᵢ²/12), (25)

where sᵢ is the step size for the quantization noise encoding operation.

As this analysis shows, the optimum bit allocation can be determined solely as a function of Pⱼ and tᵢ. And since Pⱼ and tᵢ can be determined in both a G.711 encoder and decoder, the optimum bit allocation for quantizing the quantization noise value can likewise be computed in both an encoder and a decoder. As a result, it is possible to use a narrow band enhancement layer to transmit a variable length of quantization indexes without indicating the number of bits for G.711 quantization noise for any particular sample.

Thus, if X is an input signal and Y is a decoded G.711 signal, then the G.711 quantization noise Q can be calculated as

Q=(X−Y). (26)

The quantization index Cᵢ for QN encoding, and the quantization output of the quantization noise Qᵢ would thus be:

Cᵢ= [symbol] Qᵢ/sᵢ [symbol] , (27)

and

Qᵢ′=Cᵢsᵢ, (28)

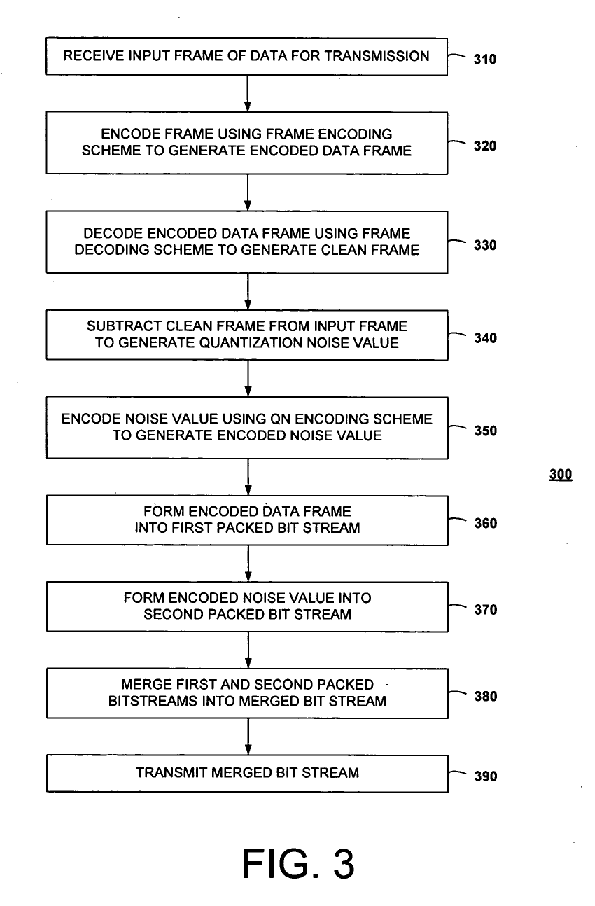

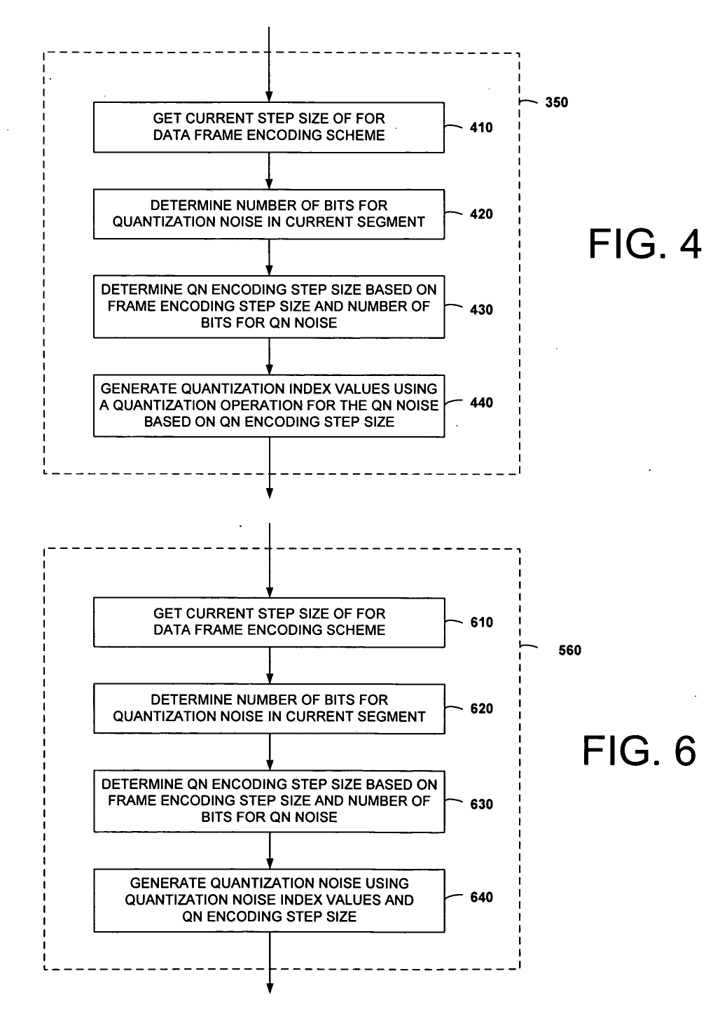

respectively. The encoding and decoding of G.711 quantization noise can then be implemented as shown in FIGS. 3 and 4 below.

In various embodiments, if the quantization noise encoding is used for a signal after noise shaping, then the input may be a shaped signal.

Complexity and Performance

One additional issue to consider when determining whether an encoding operation can be effectively used in a voice or video codec is whether encoded frames, including quantized noise values, can be decoded quickly enough to maintain a desired quality of service. A simple analysis of the disclosed QN encoding operation will show that encoded QN values can be decoded quickly enough to maintain adequate voice or video quality.

The process of generating encoded QN values includes the operations of calculating the optimum bit allocation bᵢ, the determination of the quantization noise, and the packing of variable length bit streams. In equation (21), tᵢ is a power of 2, and log₂(tᵢ) is the segment number. The calculation of bᵢ requires M multiplications, one division and three additions per frame. Assigning remaining bits requires, at most, an additional 3M operations per frame.

Calculating the quantization noise requires about two operations/sample; quantizing the G.711 quantization noise requires about two operations/sample; and the packing of the bit stream requires about seven operations/sample. Thus, the total operations/sample for these three operations is about eleven.

From this is it is possible to determine that the total weighted millions of operations per second (WMOPS) of the QN encoder is therefore

(M+3+D+3M+11N)/N/125<((35+D)/N+11)/125, (29)

where D is number of operation per short division. The WMOPS in the decoder will be similar to the decoder.

If D is chosen to be 18, then the WMOPS for both encoder and decoder are 0.1972 for a 5 ms frame size. This value is sufficient to allow these operations to be performed while maintaining acceptable voice communication.

Comparison with Uniform Quantization

One useful comparison is between the proposed noise quantization operation and a uniform quantization operation (i.e., one having a uniform step size throughout). The effectiveness of the proposed noise quantization operation can be shown by the resulting means square error (MSE) and signal to noise ratio (SNR) for each operation.

The MSE and SNR for a G.711 encoder can be calculated as:

$$\begin{matrix}{MSE}_{1} = {\sum }_{i = 1}^{Ns} {( {X}_{i} - {Y}_{i} )}^{2} / Ns , & ( 30 ) \\ {MSE}_{2} = {\sum }_{i = 1}^{Ns} {( {X}_{i} - {Y}_{i}^{′} )}^{2} / Ns , \\ and & ( 31 ) \\ SNR = 10 {log}_{10} ( {MSE}_{1} / {MSE}_{2} ) & ( 32 )\end{matrix}$$

where Xᵢ and Yᵢ are the G.711 i^{th} encoder input signal and the decoded output, respectively; and Yᵢ′ is the narrowband enhancement (NBE) decoder output, i.e.,

Yᵢ′=Yᵢ+Qᵢ′. (33)

In this analysis, the input signal of the G.711 encoder is a low-band signal that is resealed to 14 bits, using a G.711 wideband enhancement (WBE) baseline code. This analysis will show similar performance in embodiments in which its input is the signal after noise shaping.

TABLE 1
Performance of G.711 Narrowband Enhancement*

| | MSE₁/MSE₂ | SNR (dB) |
|---|---|---|
| Uniform Quantization | 4.0767 | 6.1031 |
| Disclosed Quantization | 38.2474 | 15.8260 |

*performance does not include noise shaping

As shown in Table 1, using the disclosed quantization operation for encoding the quantization noise values gives a significant increase in MSE and SNR.

Quantization Encoder

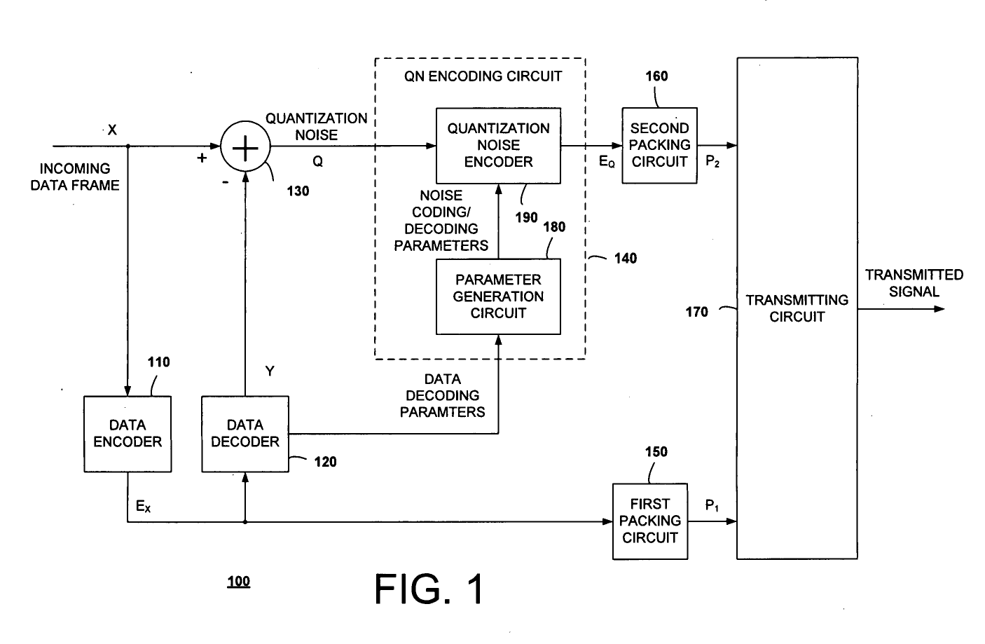

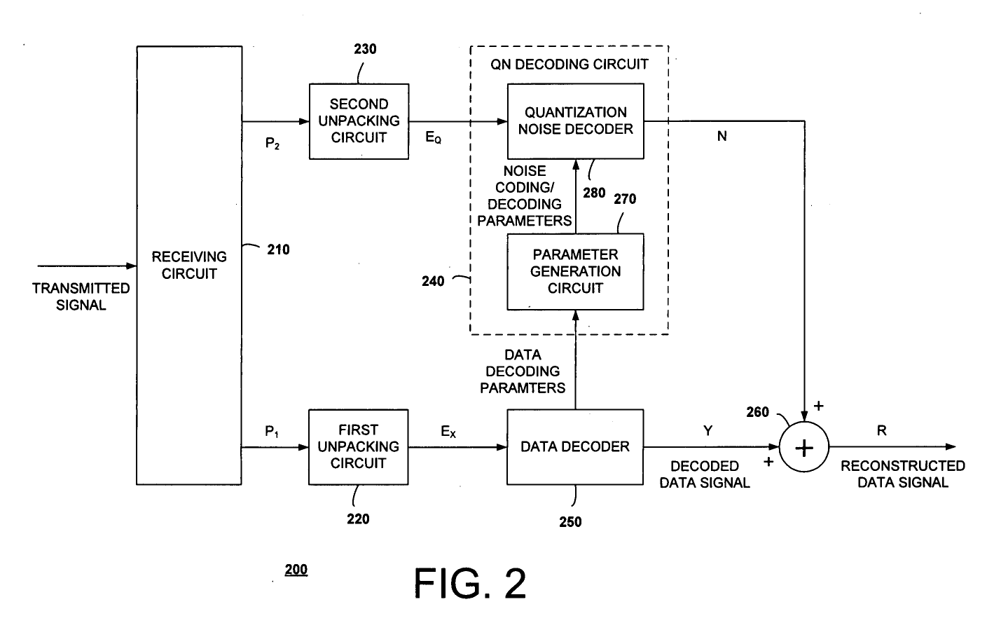

FIG. 1 is a block diagram of a transmitter device 100 according to disclosed embodiments. The disclosed transmitter device 100 can be used with a G.711 codec. The transmitter device 100 performs the necessary functions for quantizing a received signal to generate an encoded signal of a desired size that can be transmitted to a remote device. Simple transmitter devices may contain only a quantization encoder 100. However, transceiver devices should contain both a quantization encoder 100 and a quantization decoder 200. (See, FIG. 2 below.)

As shown in FIG. 1, the quantization encoder 100 includes a data frame encoder 110, a data frame decoder 120, a subtractor 130, a quantization noise (QN) encoding circuit 140, a first packing circuit 150, a second packing circuit 160, and a transmitting circuit 170. The QN encoding circuit 140 further includes a parameter generation circuit 180 and a quantization noise encoder 190.

The data frame encoder 110 receives an input signal X at a base data rate (e.g., 128 kbps) and quantizes it to generate an encoded input signal Eₓ at a lesser data rate (e.g., 64 kbps) according to a particular codec.

The data frame decoder 120 receives the encoded input signal Eₓ and decodes it to generate a decoded signal Y. The data frame encoded 110 and the data frame decoder 120 both use the same codec for their coding and decoding operations. As a result, the decoded signal Y represents the signal that a receiver would be able to decode from the coded signal X, setting aside channel losses.

In the disclosed embodiment the data frame encoder 110 and the data frame decoder 120 both use the G.711 codec for coding and decoding. However, alternate embodiments could use a different codec in the data frame encoder 110 and the data frame decoder 120.

The subtractor 130 subtracts the decoded signal Y from the input signal X to generate a quantization noise value Q. The quantization noise value Q represents the difference between the actual signal received by the transmitter device 100 and the encoded data signal Eₓ sent to a receiver device.

The QN encoding circuit 140 receives the quantization noise value Q and quantizes it to generate an encoded noise signal E_{Q} at a lesser data rate (e.g., 16 kbps). In particular, the parameter generation circuit 180 receives frame decoding parameters from the data frame decoder 120 and use these frame decoding parameters to generate noise encoding/decoding parameters to be used by the quantization noise encoder 190. As shown above, these frame decoding parameters can include the quantization step size of the i^{th} quantization segment (tᵢ), and the probability that a quantization input is from an i^{th} quantization segment (Pᵢ). In some embodiments, this can be in the form of a histogram of tᵢ and Pᵢ for each segment.

In alternate embodiments, the parameter generation circuit 180 could receive the frame decoding parameters from the data frame encoder 110 in addition to or instead of from the data frame decoder 120.

The quantization noise encoder 190 then uses the noise encoding/decoding parameters to encode the quantization noise value Q appropriately into the encoded noise signal E_{Q} according to a particular codec.

The first packing circuit 150 packs the encoded data signal E_{X} into a first packed signal P₁ suitable for transmission; and the second packing circuit 160 packs the encoded noise signal E_{Q} into a second packed signal P₂ suitable for transmission.

Then the transmitting circuit 170 receives the first and second packed signals P₁ and P₂, and transmits them to a remote receiver. This can be done using whatever physical transmission parameters are desirable.

Although separate first and second packing circuits 150 and 160 are disclosed in this embodiment, alternate embodiments could eliminate these circuits and have the transmitting circuit 170 directly receive the encoded data signal Eₓ and the encoded noise signal E_{Q} and form them into the transmitted signal in another way.

Quantization Decoder

FIG. 2 is a block diagram of a quantization decoder 200 according to disclosed embodiments. The quantization decoder 200 performs the necessary functions of decoding an encoded (i.e., quantized) signal received from a quantization encoder 100. Simple receiver devices may contain only a quantization decoder 200. However, transceiver devices should contain both a quantization encoder 100 and a quantization decoder 200.

As shown in FIG. 2, the quantization decoder 200 includes a receiving circuit 210, a first unpacking circuit 220, a second unpacking circuit 230, a quantization noise (QN) decoding circuit 240, a data frame decoder 250, and a summer 260. The QN decoding circuit 240 further includes a parameter generation circuit 270 and a quantization noise decoder 280.

The receiving circuit 210 receives the transmitted signal sent from a transmitter device 100. In the disclosed embodiment, the transmitted signal includes both a first packed signal P₁ containing an encoded data signal Eₓ and a second packed signal P₂ containing an encoded noise signal E_{Q}.

The first unpacking circuit 220 unpacks the first packed signal P₁ to extract the encoded data signal E_{X}, and the second unpacking circuit 230 unpacks the second packed signal P₂ to extract the encoded noise signal E_{Q}.

Although separate first and second unpacking circuits 220 and 230 are disclosed in this embodiment, alternate embodiments could eliminate these circuits and have the receiving circuit 210 directly extract the encoded data signal Eₓ and the encoded noise signal E_{Q} from the transmitted signal it receives.

The QN decoding circuit 240 receives the encoded noise signal E_{Q} and decodes it to generate a noise signal N. This noise signal N will not be identical to the quantization noise signal Q because of its own quantization noise. However, it will provide a measure of the original quantization noise from the data quantization operation in the transmitter device 100.

In particular, the parameter generation circuit 270 in the QN decoding circuit 240 will receive frame decoding parameters from the data frame decoder 250 and use these frame decoding parameters to generate noise encoding/decoding parameters to be used by the quantization noise decoder 280. As shown above, these frame decoding parameters can include the quantization step size of the i^{th} quantization segment (tᵢ), and the probability that a quantization input is from an i^{th} quantization segment (Pᵢ). In some embodiments, this can be in the form of a histogram of tᵢ and Pᵢ for each quantization segment.

The quantization noise decoder 280 then uses the noise encoding/decoding parameters to decode the noise value N from the encoded noise signal E_{Q} using the same codec used to encode the encoded noise signal E_{Q}.

The data frame decoder 250 receives the encoded data signal Eₓ from the first unpacking circuit 220, and extracts the decoded data signal Y from the encoded data signal Eₓ using the same codec used to encode the encoded data signal Eₓ.

The summer 260 then adds the noise signal N to the decoded data signal Y to generate a reconstructed data signal R. By adjusting the decoded data signal Y to account, in part, for the quantization noise Q, this reconstructed signal R helps bring the quality of the reconstructed data signal R closer to the quality of the incoming data signal X at the transmitter.

Quantization Encoding Operation

FIG. 3 is a flow chart of a data quantization encoding operation 300 according to disclosed embodiments. As shown in FIG. 3, the data quantization encoding operation 300 begins when a transmitter device receives an input frame of data, such as a frame of speech, for transmission (310).

The transmitter then encodes the frame using a frame encoding scheme to generate an encoded data frame (320). In some embodiments this encoding can be performed using a G.711 codec (alaw or μlaw). However alternate embodiments can use other codecs, such as a G.729 codec, an MPEG 4 codec, or any other audio, video, or other type of suitable codec.

The transmitter then decodes the encoded data frame using the frame decoding scheme that will be used at a receiver to generate a clean data frame (330), and subtracts the clean data frame from the input data frame to generate a quantization noise value (340).

The transmitter then encodes this quantization noise value using a quantization noise encoding scheme to generate an encoded noise value (350). The quantization noise (QN) encoding scheme may use the same or a different codec as the data encoding scheme. If the transmitter employs the same codec for data encoding and QN encoding, it may use different encoding parameters for each encoding operation. In some embodiments the QN encoding/decoding parameters can be derived from one or more data encoding/decoding parameters.

The transmitter then forms the encoded data frame into a first packed bit stream (360); forms the encoded quantization noise value into a second packed bit stream (370); merges the first and second packed bit streams into a merged bit stream (380); and transmits the merged bit stream (390).

This operation can then be repeated for as many frames of data as need to be transmitted.

The operations of forming encoded data frames and encoded noise values into first and second packed bit streams, merging the packed bit streams, and transmitting the merged bit stream are shown by way of example only. In alternate embodiments, these operations can be replaced by another method of transmitting the encoded data frame and the encoded QN value to a receiver device.

FIG. 4 is a flow chart of a quantization noise (QN) encoding operation 350 in the data quantization encoding operation according to disclosed embodiments. As shown in FIG. 4, the QN encoding operation uses information from the data encoding/decoding operations (320, 330) to perform QN encoding.

In the disclosed QN encoding operation 350, the transmitter device begins by receiving the current step size tᵢ for the data frame encoding scheme (410).

The transmitter device also determines the number of bits bᵢ for quantization noise in a current segment (420). This can be done by generating a histogram of known information from the data-encoding process (e.g., segment step size tᵢ, and number of samples per segment Nᵢ).

Based on the current step size tᵢ and the number of bits for quantization noise bᵢ, the transmitter calculates the necessary quantization step sizes sᵢ (430). And then, based on the calculated quantization noise Qᵢ and the quantization step size sᵢ, the transmitter generates the quantization index values Cᵢ for the quantization encoding (440).

In this way, the transmitter device encodes the quantization noise Q using data that can be obtained from the data decoding operation. And although in this embodiment the noise encoding parameters are determined from the segment step size tᵢ, and the number of samples per segment Nᵢ, alternate embodiments could use different parameters for noise encoding.

Regardless, by using some of the data decoding parameters to generate the noise encoding/decoding parameters, the transmitter device need send no additional information to the receiver device to allow it to decode the encoded QN value. Since the receiver device will perform a data decoding operation, it will already generate the necessary data to perform the QN value decoding operation as well.

Quantization Decoding Operation

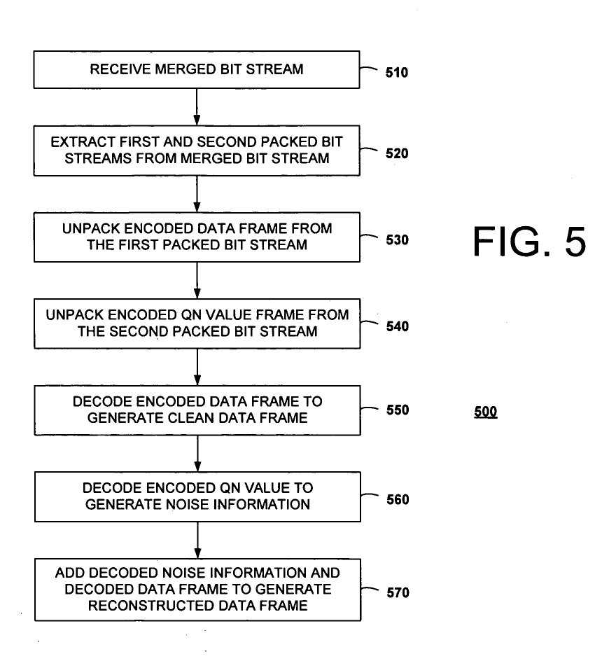

FIG. 5 is a flow chart of data quantization decoding operation 500 according to disclosed embodiments. As shown in FIG. 5, the data quantization decoding operation 500 begins when a merged bit stream is received from a transmitter device (510).

The receiver device then extracts first and second packed bit streams from the merged bit stream (520), extracts an encoded data frame from the first packed bit stream (530), and extracts an encoded QN value from the second packed bit stream (540).

The use of a merged bit stream in the disclosed embodiments is shown by way of example only, however. In alternate embodiments other methods of transmitting the encoded data frame and the encoded QN value to the receiver device can be used. In such embodiments, corresponding methods of receiving the encoded data frame and the encoded QN value may be employed.

Once it receives the encoded data frame and the encoded QN value, the receiver device then decodes the encoded data frame to generate a clean frame (550) and decodes the encoded QN value to generate noise information (560). The decoding of the encoded data frame (550) is performed using the agreed upon codec for data transmission. The decoding of the QN value (560) is performed using a known noise codec, and based on data decoding parameters received from a data decoder. The noise codec may be the same or a different codec than the one used for data encoding/decoding.

Once the clean data and the noise information have been generated, the two are added together to form reconstructed data frame (570). This reconstructed data frame will have a greater quality than had it only been sent as the clean frame, since the reconstructed frame includes an adjustment to account for at least part of the quantization error.

FIG. 6 is a flow chart of a quantization noise (QN) decoding operation in the data quantization decoding operation 560 according to disclosed embodiments. As shown in FIG. 6, the QN decoding operation uses information from the data decoding operation (550) to perform QN decoding.

In the disclosed QN decoding operation 560, the transmitter device begins by receiving the current step size tᵢ for the data frame encoding scheme (610).

The transmitter device also determines the number of bits bᵢ for quantization noise in a current quantization segment (620). This can be done by generating a histogram of known information from the data-encoding process (e.g., segment step size tᵢ, and number of samples per quantization segment Nᵢ).

Based on the current step size tᵢ and the number of bits for quantization noise bᵢ, the transmitter calculates the necessary quantization step sizes sᵢ (630). And then, based on quantization index values Cᵢ extracted from the encoded QN value, and the quantization step size sᵢ, the transmitter generates corresponding quantization noise values Qᵢ to generate the noise information (640).

In this way, the transmitter device decodes the encoded quantization noise Q using data that can be obtained from the data decoding operation. And although in this embodiment the noise decoding parameters are determined from the quantization segment step size tᵢ, and the number of samples per quantization segment Nᵢ, alternate embodiments could use different parameters for noise decoding.

Regardless, by using some of the data decoding parameters to generate the noise encoding/decoding parameters, the receiver device decodes the encoded QN value using data that can be obtained from the data decoding operation. As a result, the transmitter device need send no additional information to the receiver device to allow it to decode the encoded QN value. Since the receiver device will perform a data decoding operation, it will already generate the necessary data to perform the QN value decoding operation as well.

### CONCLUSION

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A data encoding device, comprising:
a data frame encoder configured to receive an incoming frame of data and to generate an encoded frame of data using a frame encoding scheme;
a data frame decoder configured to receive the encoded frame of data and to generate a decoded frame of data using the frame encoding scheme, and frame decoding parameters;
a subtractor configured to subtract the decoded frame of data from the incoming frame of data to generate base quantization noise information;
a quantization noise encoder configured to receive the base quantization noise information and the frame decoding parameters, and to generate encoded quantization noise information using a noise encoding scheme; and
a transmitting circuit configured to transmit the encoded frame of data and the encoded quantization noise information.

2. The device of claim 1, wherein
the frame encoding scheme is determined based on a G.711 enhancement codec,
the encoded data frame is formed in a layer one bit stream,
the encoded quantization noise information is formed in a layer two bit stream, and
the transmitting circuit is configured to transmit the layer one and layer two bit streams.

3. The device of claim 1, further comprising
a first packing circuit configured to pack the encoded frame of data into a first bit stream; and
a second packing circuit configured to pack the encoded quantization noise information into a second bit stream,
wherein the transmitting circuit is configured to merge the first and second bit streams into a third bit stream, and to transmit the third bit stream over a transmission medium.

4. The device of claim 1, wherein the frame decoding parameters include quantization index values for the data frame decoder and quantization step size values for the data frame decoder.

5. The device of claim 1, wherein the encoding of the base quantization noise information comprises calculating a probability density function of the base quantization noise information.

6. The device of claim 1, wherein the frame encoding scheme is determined based on a multi-segment uniform scalar quantization encoding scheme.

7. The device of claim 1, wherein
the coding scheme coder is configured to quantize the incoming frame of data for a bit rate of 64 kilobits per second, and
wherein the quantization noise encoder is configured to quantize the base quantization noise information for a bit rate of 16 kilobits per second.

8. A method of encoding an incoming frame of data, comprising:
receiving the incoming frame of data;
encoding the incoming frame of data using a frame encoding scheme to generate an encoded frame of data;
decoding the encoded frame of data using a frame decoding scheme to generate a decoded frame of data and decoding data;
subtracting the decoded frame of data from the incoming frame of data to generate base quantization noise information;
encoding the base quantization noise information using a quantization noise encoding scheme and the decoding parameters to generate encoded quantization noise information; and
transmitting the encoded frame of data and the encoded quantization noise information over a transmission medium,
wherein the encoding of the base quantization noise information is performed using parameters based on the decoding of the encoded frame of data.

9. The method of claim 8, further comprising
packing the encoded frame of data into a first bit stream;
packing the encoded quantization noise information into a second bit stream; and
merging the first and second bit streams into a third bit stream,
wherein the transmitting of the encoded frame of data and of the encoded quantization noise information includes transmitting the third bit stream.

10. The method of claim 8, wherein the frame decoding parameters includes frame quantization index values for the decoding of the encoded frame of data and quantization segment step size values for the decoding of the encoded frame of data.

11. The method of claim 10, wherein the encoding of the base quantization noise information further comprises:
determining a plurality of bit sizes for encoding the base quantization noise information separately for a plurality of quantization segments; and
determining a plurality of noise quantization step size values for the plurality of quantization segments of the base quantization noise information based on the plurality of quantization segment step size values and the plurality of bit sizes.

12. The method of claim 11,
wherein the frame of data is divided up into M quantization segments,
wherein B represents an average number of bits of quantization noise per sample
wherein the number of bits bᵢ for an i^{th} quantization segment of the quantization noise is equal to
$$[ [ {b}_{i} = ⌊ {log}_{2} ( {t}_{i} ) - {\sum }_{j = 1}^{M} {P}_{i} {log}_{2} ( {t}_{j} ) + B ⌋ , ] ]$$
$${b}_{i} = ⌊ {log}_{2} ( {t}_{i} ) - {\sum }_{j = 1}^{M} {P}_{i} {log}_{2} ( {t}_{j} ) + B ⌋$$
wherein the noise quantization step size value for the i^{th} quantization segment of the base quantization noise is equal to
$${s}_{i} = \frac{{t}_{i}}{{2}^{{b}_{i}}} ,$$
wherein tᵢ is a quantization segment step size value for the i^{th} quantization segment of the quantization noise, and Pⱼ is a probability density function for the j^{th} quantization segment of the quantization noise, and
wherein M, B, bᵢ, are all integers.

13. The method of claim 8, wherein the encoding of the base quantization noise information comprises calculating a probability density function of the quantization noise information.

14. The method of claim 8, wherein the encoding of the incoming frame of data and the decoding of the encoded frame of data are both performed using a G.711 codec.

15. A data decoding device, comprising:
a receiving circuit configured to receive an encoded frame of data and encoded quantization noise information;
a data frame decoder configured to receive the encoded frame of data and to generate a decoded frame of data using a frame encoding scheme, and frame decoding parameters;
a quantization noise decoder configured to receive the encoded quantization noise information and the frame decoding parameters, and to generate a decoded quantization noise information using a noise decoding scheme; and
an adder configured to add the decoded frame of data and the quantization noise information to generate a reconstructed data frame.

16. The device of claim 15, wherein
the frame decoding scheme is determined based on a G.711 wideband enhancement codec,
the encoded frame of data is formed in a layer one bit stream,
the encoded quantization noise information is formed in a layer two bit stream, and
the receiving circuit is configured to receive the layer one and layer two bit streams and to extract the encoded frame of data and the encoded quantization noise value.

17. The device of claim 15, further comprising
a first unpacking circuit configured to unpack the first bit stream to retrieve the encoded frame of data; and
a second unpacking circuit configured to unpack the second bit stream to retrieve the encoded quantization noise information,
wherein the receiving circuit is configured to receive a third bit stream containing the first and second bit streams, and to extract the first and second bit streams from the third bit stream.

18. The device of claim 15, wherein the frame decoding parameters include quantization index values for the data frame decoder and quantization step size values for the data frame decoder.

19. The device of claim 15, wherein the decoding of the base quantization noise information comprises calculating a probability density function of the quantization noise information.

20. The device of claim 15, wherein the frame encoding scheme is determined based on a G.711 codec.

21. A method of generating a reconstructed frame of data, comprising:
receiving an encoded frame of data and an encoded quantization noise information;
decoding the encoded frame of data using a frame decoding scheme to generate a decoded frame of data and decoding data;
decoding the encoded quantization noise information using a quantization noise decoding scheme and the decoding parameters to generate a decoded quantization noise information; and
adding the decoded frame of data and the decoded quantization noise information to generate the reconstructed frame of data.

22. The method of claim 21, further comprising:
splitting a third bit stream into a first bit stream containing the encoded frame of data and a second bit stream containing the encoded quantization noise information;
unpacking the first bit stream to retrieve the encoded frame of data; and
packing the second bit stream to retrieve the encoded quantization noise information,
wherein the receiving of the encoded frame of data and the encoded quantization noise value includes receiving the third bit stream.

23. The method of claim 21, wherein the frame decoding parameters includes frame quantization index values for the decoding of the encoded frame of data and quantization segment step size values for the decoding of the encoded frame of data.

24. The method of claim 23, wherein the decoding of the base quantization noise information further comprises:
determining a plurality of bit sizes for decoding a plurality of segments of the encoded quantization noise information; and
determining a plurality of noise quantization step size values for a plurality of segments of the encoded quantization noise information on the plurality of quantization segment step size values and the plurality of bit sizes.

25. The method of claim 21, wherein the decoding of the encoded quantization noise information comprises calculating a probability density function of the quantization noise information.

26. The method of claim 24,
wherein the encoded frame of data is divided up into M segments,
wherein the encoded frame of data is represented by B bits of data,
wherein the number of bits bᵢ for an i^{th} segment of quantization noise of data is equal to
$$[ [ {b}_{i} = ⌊ {log}_{2} ( {t}_{i} ) - {\sum }_{j = 1}^{M} {P}_{i} {log}_{2} ( {t}_{j} ) + B ⌋ , ] ]$$
$${b}_{i} = ⌊ {log}_{2} ( {t}_{i} ) - {\sum }_{j = 1}^{M} {P}_{i} {log}_{2} ( {t}_{j} ) + B ⌋ .$$
wherein the noise quantization step size value for the i^{th} segment of the quantization noise of data is equal to
$${s}_{i} = \frac{{t}_{i}}{{2}^{{b}_{i}}} ,$$
wherein tᵢ is a quantization segment step size value for the i^{th} segment of the quantization noise, and Pⱼ is a probability density function for the J^{th} segment of the quantization noise, and
wherein M, B, bᵢ, are all integers.

27. The method of claim 21, wherein the decoding of the encoded frame of data is performed using a multi-segment uniform scalar quantization encoding scheme.
